(19) United States
(12) Patent Application Publication
(10) Pub. No.: US 2014/0065969 A1
(43) Pub. Date: Mar. 6, 2014

(54) METHOD FOR CONNECTIVITY INFORMATION CONTROL AND AN ELECTRONIC DEVICE THEREOF

(71) Applicant: Samsung Electronics Co., Ltd., Gyeonggi-do (KR)

(72) Inventors: Hyun-Chul CHOI, Seoul (KR); Hyuk KANG, Gyeonggi-do (KR); Hyeong-Seok KIM, Seoul (KR)

(73) Assignee: Samsung Electronics Co., Ltd., Gyeonggi-do (KR)

(21) Appl. No.: 14/012,139

(22) Filed: Aug. 28, 2013

(30) Foreign Application Priority Data
Aug. 28, 2012 (KR) 10-2012-0094159

(51) Int. Cl. H04W 76/02

(52) U.S. Cl. CPC H04W 76/023
USPC 455/41.2

(57) ABSTRACT

A method and apparatus for controlling connectivity information in an electronic device. The method includes receiving connectivity information on at least one wireless device, analyzing the received connectivity information, and establishing a connection with a neighbor wireless device by using the connectivity information. A first electronic device may store connectivity information with respect to the plurality of wireless devices. A second electronic device can receive a connectivity information file transmitted from the first electronic device. In the case where a second electronic device attempts to initially establish a connection with the plurality of neighbor wireless devices, the second electronic device can easily establish a connection with the plurality of wireless devices by decoding a connectivity information file transmitted from the first electronic device.

### CLAIM OF PRIORITY

This application claims the benefit under 35 U.S.C. §119(a) from a Korean patent application filed in the Korean Intellectual Property Office on Aug. 28, 2012 and assigned Serial No. 10-2012-0094159, the entire disclosure of which is hereby incorporated by reference in its entirety.

### BACKGROUND

1. Field of the Disclosure

The present disclosure relates to a method and apparatus for controlling connectivity information in an electronic device. More particularly, the present disclosure is related to a method for wireless connection with a neighboring electronic device, typically by short-range communication.

2. Description of the Related Art

With the development of a number of communication techniques, there is a growing demand to design wireless devices that are smaller in size than previously known devices and have greater portability than previous generations of electronic devices.

Some representative examples of the wireless devices include a portable electronic device such as a mobile phone, smart phone, Personal Digital Assistant (PDA), tablet, phablet, smart camera, and Portable Media Player (PMP) capable of exchanging information with another device. In particular, there are many cases in which the wireless devices will also drive applications in addition to executing an original function in order to satisfy various consumer demands, which requires establishment of a connection with another device.

For example, in the case were the mobile phone is a representative example of the wireless device, although the mobile phone originally was designed to provide a call service, more recent versions of mobile phones provide for an a Motion Picture Experts Group Layer 3 (MP3) player function to output music. In this case, a speaker included in the mobile phone for voice communication may also be used to output the music. If necessary or if privacy is desired, an earphone can be used to output the music. In case of using the earphone, the portable terminal and the earphone must be connected in a wired fashion.

Conventionally, the earphone and the mobile phone are connected in a physically wired fashion in terms of reliability of information delivery. However, with the development of wireless communication techniques, reliable information delivery has become possible without a physically wired medium for delivering a signal to the earphone or even an external speaker. Further, in operation users find it more convenient to have the mobile phone and the earphone (or other external device) wirelessly coupled because manipulation of the mobile phone can become quite cumbersome due to having a number of lines connected to various external devices, such as in the case wherein a wire from an external device is connected to the mobile phone and the user is accessing another function of the mobile phone and turns the phone from a portrait position to a landscape position, or utilizes gestures that might include movement of the mobile phone.

With regard to a wireless coupling between the mobile phone and an external device, a representative example of such a wireless connection is an earphone and a mobile phone supporting a Bluetooth mechanism.

A wireless connection between devices is simple since there is no physical wire for connecting the respective devices that can act as an unwanted tether. However, the protocols to initialize wireless communication using, for example, Bluetooth is rather inconvenient because undertaking an additional setting process is required according to a characteristic of the protocol of the wireless communication. More particularly, a wireless communication channel must be established in advance between devices to establish the wireless connection. In order to establish the wireless communication channel, a communication protocol including a data package size, a communication mechanism, etc., must be set to configure the wireless communication channel for effective communication between the devices based in part on the capabilities of the devices.

When the mobile phone and the earphone are connected via s short-range communication protocol, such as by using the Bluetooth mechanism, a method is used in which a user manipulates the mobile phone to drive a Bluetooth mode, the mobile phone searches for a neighbor Bluetooth device and displays the found device on a display unit of the mobile phone. Then, the user selects the earphone to be connected from a displayed device list and registers the selected earphone.

Such a method must be aware of unique information of a wireless device to which the user intends to establish a connection. For example, the user may not always readily detect from the displayed list of neighboring devices which particular device constitutes earphone for which a connection is desired. In addition, it is inconvenient to manipulate the mobile phone to input each of various pieces of information for a wireless connection.

### SUMMARY

An aspect of the present disclosure is to solve at least some of the above-mentioned problems and/or disadvantages and to provide a novel and non-obvious connectivity information control method heretofore unknown, in which an electronic device establishes a connection with a wireless device, and an electronic device thereof.

Another aspect of the present disclosure is to provide a connectivity information control method in which an electronic device establishes a connection with a wireless device by using connectivity information, and an electronic device thereof.

Yet another aspect of the present disclosure is to provide a connectivity information control method in which an electronic device creates connectivity information with respect to a wireless device, and an electronic device thereof.

In accordance with an aspect of the present disclosure, a method of receiving connectivity information in an electronic device includes wirelessly receiving connectivity information regarding at least one wireless device, analyzing the received connectivity information, and establishing a connection with a neighbor wireless device by using the connectivity information.

In accordance with another aspect of the present disclosure, a method of transmitting connectivity information includes creating connectivity information on at least one wireless device, and transmitting the created connectivity information.

In accordance with another aspect of the present disclosure, an electronic device includes at least one processor, at least one touch screen, a memory, and at least one program comprising machine executable code stored in the memory and configured to be executable by the at least one processor, wherein when executed by the at least one processor controls a communication unit receiving connectivity information on at least one wireless device, analyzing the received connectivity information, and establishing a connection with a neighbor wireless device by using the connectivity information.

In accordance with another aspect of the present disclosure, an electronic device includes at least one processor, at least one touch screen, a memory, and at least one program comprising machine executable code stored in the memory and configured to be executable by the at least one processor, wherein the program includes at least one instruction for creating connectivity information on at least one wireless device, and transmitting the created connectivity information.

In accordance with another aspect of the present disclosure, a system for transmitting and receiving connectivity information in an electronic includes a first electronic device for creating and transmitting connectivity information on at least one wireless device, and a second electronic device for receiving the connectivity information created by the first electronic device and for establishing a connection with at least one neighbor wireless device by using the received connectivity information.

### BRIEF DESCRIPTION OF THE DRAWINGS

The above and other aspects, features and advantages of certain exemplary embodiments of the present disclosure will become better understood and appreciated by a person of ordinary skill in the art from the following detailed description taken in conjunction with the accompanying drawings, in which:

FIG. 1 is a block diagram of an electronic device according to an exemplary embodiment of the present disclosure;

FIG. 2 is a block diagram of a processor according to an exemplary embodiment of the present disclosure;

FIG. 3A illustrates a structure of a system for transmitting and receiving a connectivity information package between electronic devices according to a an exemplary embodiment of the present disclosure;

FIG. 3B illustrates a structure of a system for transmitting and receiving a connectivity information package between electronic devices according to a an exemplary embodiment of the present disclosure;

FIG. 4 illustrates exemplary operation of a process of creating a connectivity information package in an electronic device according to an exemplary embodiment of the present disclosure;

FIG. 5 illustrates exemplary operation of a process of determining whether to authenticate a connectivity information package in an electronic device according to an exemplary embodiment of the present disclosure;

FIG. 6 illustrates exemplary operation of a process of determining a validity of a connectivity information package in an electronic device according to an exemplary embodiment of the present disclosure;

FIG. 7A and FIG. 7B illustrate a screen configuration for creating a connectivity information package in an electronic device according to an exemplary embodiment of the present disclosure;

FIG. 8A illustrates exemplary operation of a process of establishing a connection with a device by considering connectivity information in an electronic device according to a first exemplary embodiment of the present disclosure;

FIG. 8B illustrates exemplary operation of a structure of an electronic device for establishing a connection with a device by considering connectivity information in an electronic device according to an exemplary embodiment of the present disclosure;

FIG. 9 illustrates exemplary operation of a process of establishing a connection with a device by considering connectivity information in an electronic device according to a second exemplary embodiment of the present disclosure;

FIG. 10 illustrates exemplary operation of a process of authenticating a connectivity information package in an electronic device according to an exemplary embodiment of the present disclosure;

FIG. 11 illustrates exemplary operation of a process of determining a validity of a connectivity information package in an electronic device according to an exemplary embodiment of the present disclosure; and

FIGS. 12A, 12B, 12C and 12D illustrate a screen configuration for establishing a connection with a device by considering connectivity information in an electronic device according to an exemplary embodiment of the present disclosure.

### DETAILED DESCRIPTION

Exemplary embodiments of the present disclosure will now be described herein below with reference to the accompanying drawings. In the following description, well-known functions or constructions may not described in detail when their inclusion could obscure appreciation of the disclosure by a person of ordinary skill in the art with in unnecessary detail. Also, the terms used herein are defined according to the functions of the present disclosure. Thus, the terms may vary depending on user's or operator's intension and usage. In other words, the terms used herein must be understood based on the descriptions made herein.

The present disclosure described hereinafter relates to a technique for controlling inter-device connectivity information in an electronic device.

An electronic device described hereinafter includes a mobile communication terminal capable of providing a call service, a Personal Digital Assistant (PDA), a laptop, a smart phone, a netbook, a television set, a Mobile Internet Device (MID), a Ultra Mobile Personal Computer (UMPC), a tablet PC, a phablet, a navigator, a Motion Picture Experts Group Layer 3 (MP3) player, etc., just to name some non-limiting possibilities.

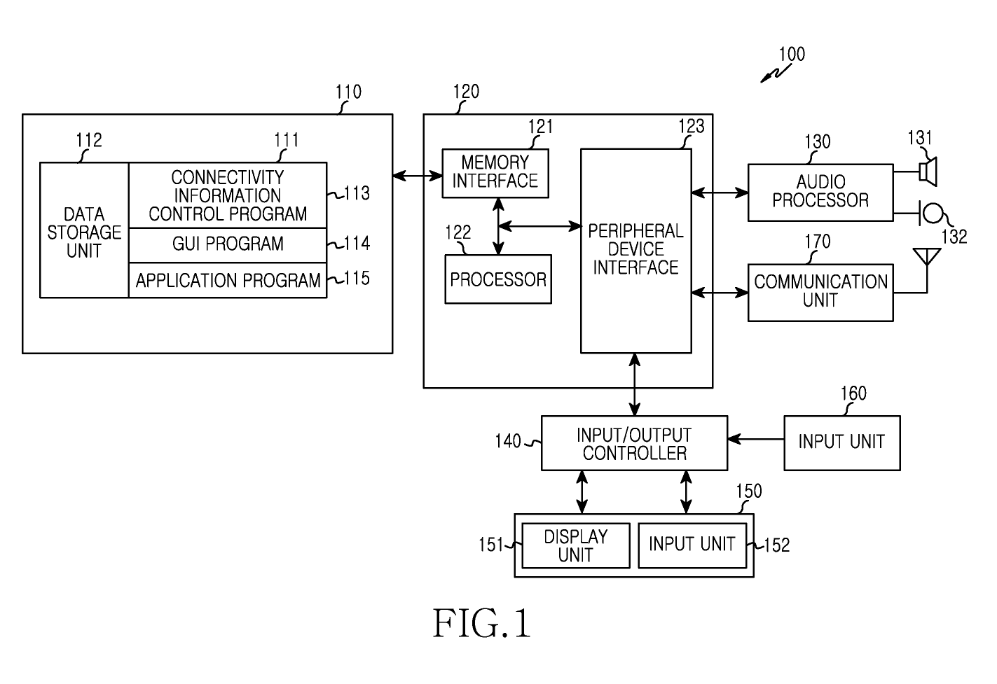

FIG. 1 is a block diagram of an electronic device according to an exemplary embodiment of the present disclosure.

Referring now to FIG. 1, an electronic device 100 includes a memory 110, a processor unit 120, an audio processor 130, an input/output controller 140, a display unit 150, an input unit 160, and a communication unit 170. Herein, the memory 110 may be plural in number.

Each component will be described below in detail.

The memory 110 is a non-transitory machine readable medium and includes a program storage unit 111 for storing a program of machine executable code that is executed by hardware such as a processor for controlling an operation of the electronic device 100 and a data storage unit 112 for storing data generated during the program is executed.

The program storage unit 111 includes a connectivity information control program 113, a Graphic User Interface (GUI) program 114, and at least one application program 115. Herein, the program included in the program storage unit 111 is a group of instructions in machine executable code, and may be expressed as an instruction set that are executed by circuitry such as a processor, microprocessor, sub-processor, etc.

The data storage unit 112 includes storage of at least one software component regarding connectivity information. For example, the data storage unit 112 stores the connectivity information including at least one of a name, connectivity type, physical address, authentication status, authentication type, encryption type, and password of the wireless device.

The connectivity information control program 113 includes at least one software component for establishing a connection with a device by using the connectivity information. For example, in case of receiving the connectivity information package, the connectivity information control program 113 when loaded into and executed by circuitry such as a processor, microprocessor or sub-processor that analyzes the connectivity information package to establish a connection with the device by using the connectivity information including at least one of a name, connectivity type, physical address, authentication status, authentication type, encryption type, and password of the wireless device.

In addition, after receiving the connectivity information package, the processor, microprocessor or sub-processor executing the connectivity information control program 113 may authenticate the connectivity information package.

In addition, after receiving the connectivity information package, processor, microprocessor or sub-processor executing the connectivity information control program 113 may confirm a validity of the connectivity information package.

The GUI program 114 includes at least one software component for providing a graphic user interface on the display unit 150. In one example, the GUI program 114 when loaded into and executed by circuitry such as a processor, microprocessor or sub-processor that provides control to display a connectivity information list on the display unit 150. For another example, the GUI program 114 may provide control to display a menu for confirming whether to establish a connection to a wireless device on the display unit 150. For another example, the GUI program 114 may display an authentication window on the display unit 150 to authenticate a connectivity information package.

The application program 115 includes a software component for at least one application installed in the electronic device 100 and executed by a processor, microprocessor or sub-processor.

The processor unit 120 includes a grouping of hardware such as a memory interface 121, at least one processor 122, and a peripheral device interface 123. Herein, the memory interface 121, the at least one processor 122, and the peripheral device interface 123 included in the processor unit 120 may be integrated as at least one or more integrated circuit(s) or may be implemented as separate components.

With continued reference to FIG. 1, the memory interface 121 controls an access to the memory 110 with respect to a component such as the processor 122 or the peripheral device interface 123.

The peripheral device interface 123 controls a connection between an input/output peripheral device of the electronic device 100 and the processor 122 and the memory interface 121.

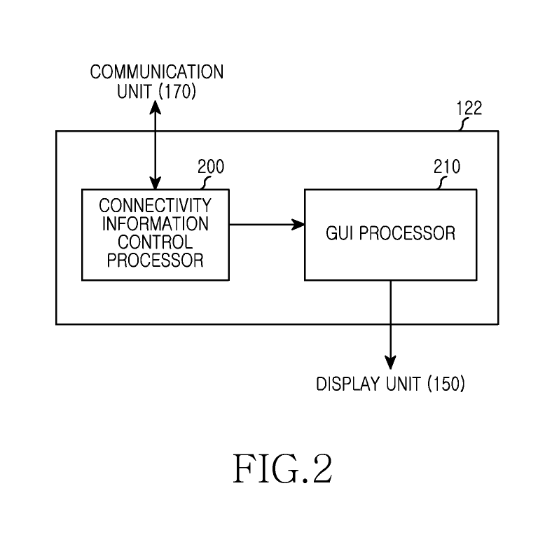

The processor 122 controls the electronic device 100 to provide various multimedia services by executing at least one software program. In this case, the processor 122 executes at least one program stored in the memory 110 to provide a service according to the program. For example, the processor 122 can be configured as illustrated in FIG. 2 to control connectivity information by executing the connectivity information control program 113.

The audio processor 130 provides an audio interface between the user and the electronic device 100 via a speaker 131 and a microphone 132.

The input/output controller 140 provides an interface and controls communications between the peripheral device interface 123 and an input/output device such as the display unit 150 and the input unit 160.

The display unit 150 includes a screen that displays status information of the electronic device 100, a character input by the user, a moving picture, a still picture, etc.

If the display unit 150 is a touch screen, the display unit 150 may further include a touch input unit or a designated area of a display screen for providing information on a touch sensed by using the touch panel to the processor unit 120 via the input/output controller 140. The touch screen may accept touch input from an entirety or less than an entirety of the displayable area, and the touch input can be entered in accordance with one or more applications that are in operation and can receive input from a touch input.

The input unit 160 provides input data generated by a user's selection to the processor unit 120 via the input/output controller 140. In one example, the input unit 160 may include only control buttons for the control of the electronic device 100. In another example, the input unit 160 may include a key pad for receiving data input from the user.

The communication unit 170 includes at least one software component for performing a communication function for voice communication and data communication as well as hardware such as a transmitter, receiver, and/or transmitter, amplifier and an antenna. In this case, the communication unit may be divided into a plurality of communication sub-modules for supporting different communication networks. For example, although not limited thereto, the communication network includes a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Local Area Network (WLAN), a Bluetooth network, Near Field Communication (NFC), etc. All of these sub-modules are associated with hardware that executes operation of one or more of the various networks such as listed herein above.

FIG. 2 is a block diagram of a processor according to an exemplary embodiment of the present disclosure.

Referring now to FIG. 2, the processor 122 includes a connectivity information control processor 200 and a GUI processor 210.

The connectivity information control processor 200, which comprises circuitry such as a processor, microprocessor or sub-processor that controls a connection with the wireless device by executing the connectivity information control program 113 of the program storage unit 111. For example, in case of receiving the connectivity information package, the connectivity information control processor 200 is configured to analyze the connectivity information package to establish a connection with the device by using the connectivity information including at least one of a name, connectivity type, physical address, authentication status, authentication type, encryption type, and password of the wireless device.

In addition, after receiving the connectivity information package, the connectivity information control processor 200 may be configured to control the authentication for the connectivity information package.

In addition, after receiving the connectivity information package, the connectivity information control processor 200 may confirm a validity of the connectivity information package.

The GUI processor 210 which includes when circuitry such as a processor, microprocessor or sub-processor that provides a graphic user interface on the display unit 150 by executing the GUI program 114 of the program storage unit 111. In one example, the GUI processor 210 provides control to display a connectivity information list on the display unit 150. In another example, the GUI processor 210 provides control to display a menu for confirming whether to establish a connection to a wireless device on the display unit 150. In still another example, the GUI processor 210 controls display of an authentication window on the display unit 150 to authenticate a connectivity information package.

In the aforementioned embodiment, the connectivity information control processor 200 of the electronic device controls the connectivity information by executing the connectivity information control program 113.

In another embodiment, the electronic device may include another connectivity information processor including the execution of the connectivity information control program 113.

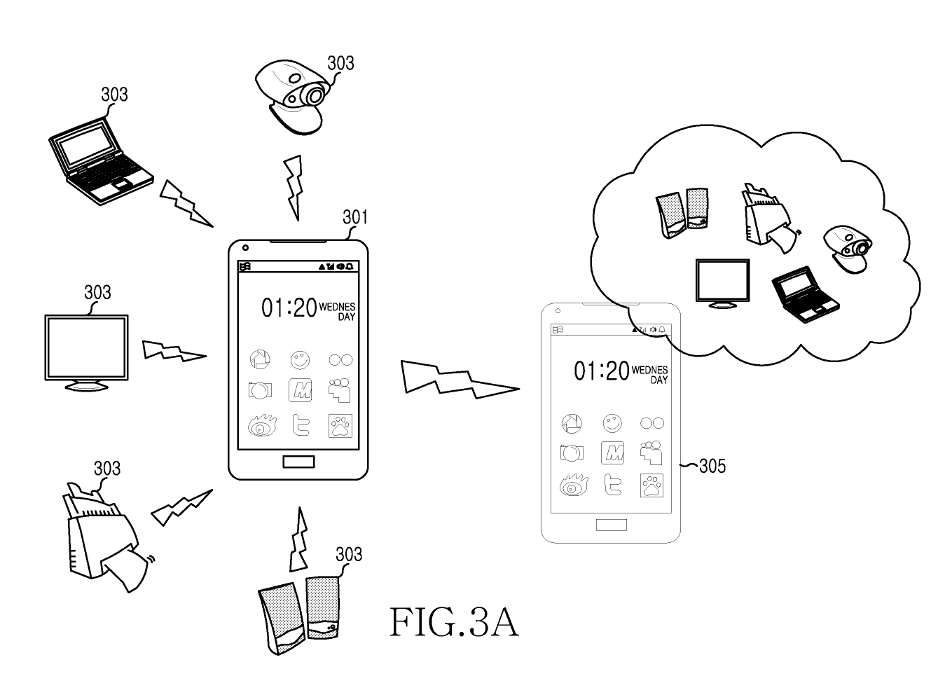

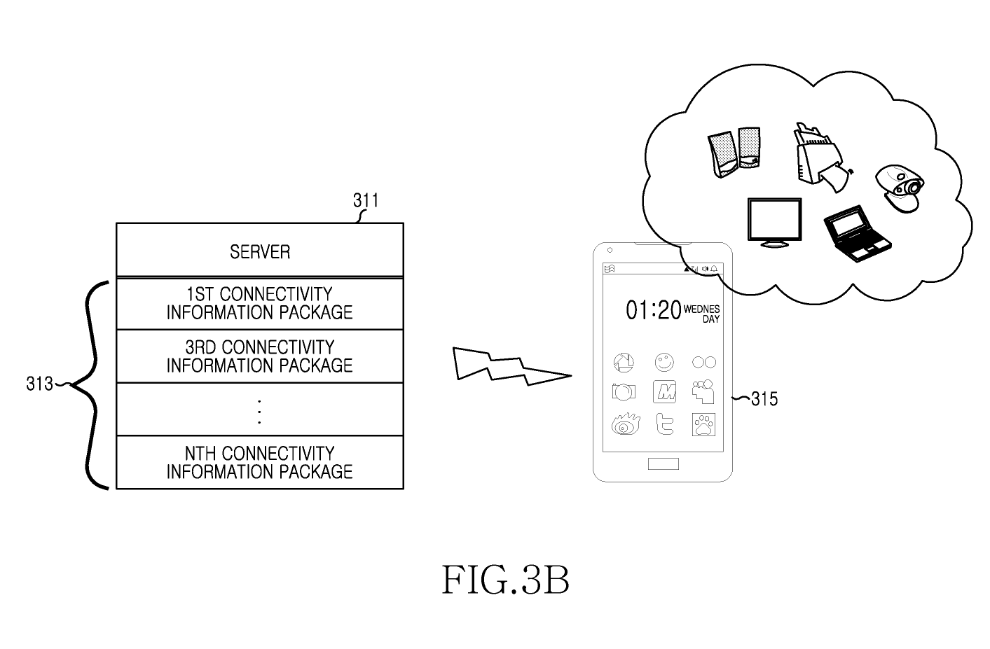

FIG. 3A illustrates a structure of a system for transmitting and receiving a connectivity information package between electronic devices according to a first exemplary embodiment of the present disclosure.

Referring now to FIG. 3A, a first electronic device 301 is wirelessly connected to a plurality of wireless devices 303, the first electronic device 301 stores connectivity information with respect to the plurality of wireless devices 303.

In the case where a second electronic device 305 attempts to initially establish a connection with one or more the plurality of wireless devices 303 (i.e. neighbor wireless devices), the second electronic device 305 attempts to establish a connection through a plurality of one or more manipulations for the respective wireless devices 303.

Accordingly, connectivity information, which can be stored in the first electronic device 301 and provided for the plurality of wireless devices 303, is transmitted to the second electronic device 305 in a file form by encoding the connectivity information, the second electronic device 305 can easily establish a connection with the plurality of wireless devices 303 (i.e. neighbor wireless devices) by decoding a connectivity information file transmitted from the first electronic device 301.

Although in the aforementioned description there is an assumption that the first electronic device 301 and the second electronic device 305 are mobile terminals, the first electronic device 301 may be a server 311 as illustrated in FIG. 3B.

FIG. 3B illustrates a structure of a system for transmitting and receiving a connectivity information package between electronic devices according to a second exemplary embodiment of the present disclosure.

Referring now to FIG. 3B, it is assumed that the server 311 stores a plurality of connectivity information packages 313. For example, if the connectivity information of wireless devices for a hotel room is encoded and is then stored in the server 311 in a file form, a first electronic device 315 can pre-store a connectivity information file of the wireless devices for a reserved room from the server 311 of the hotel.

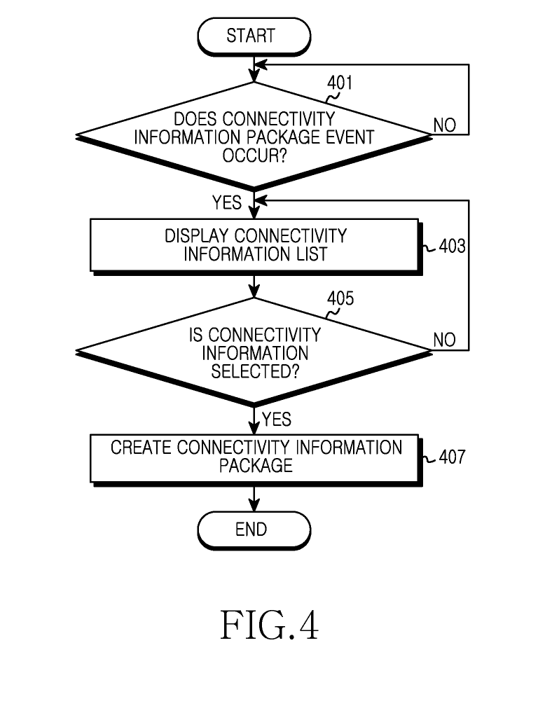

FIG. 4 illustrates an example of operation of a process of creating a connectivity information package in an electronic device according to an exemplary embodiment of the present disclosure.

Referring now to FIG. 4, at (401) the processing unit of the electronic device confirms whether a connectivity information package creation event occurs. In one example, the electronic device confirms whether an icon for creating the connectivity information package is selected. In another example, the electronic device can confirm whether the connectivity information package creation event occurs by considering input information of a hardware button (or virtual button). In another example, whether the connectivity information package creation event occurs can be determined by considering the input information of the hardware button and movement information of the electronic device. In another example, an electronic device having a touch screen can confirm whether the connectivity information package creation event occurs by considering touch information on the touch screen. For another example, the electronic device having the touch screen can determine whether the connectivity information package creation event occurs by considering the touch information on the touch screen and the movement information of the electronic device.

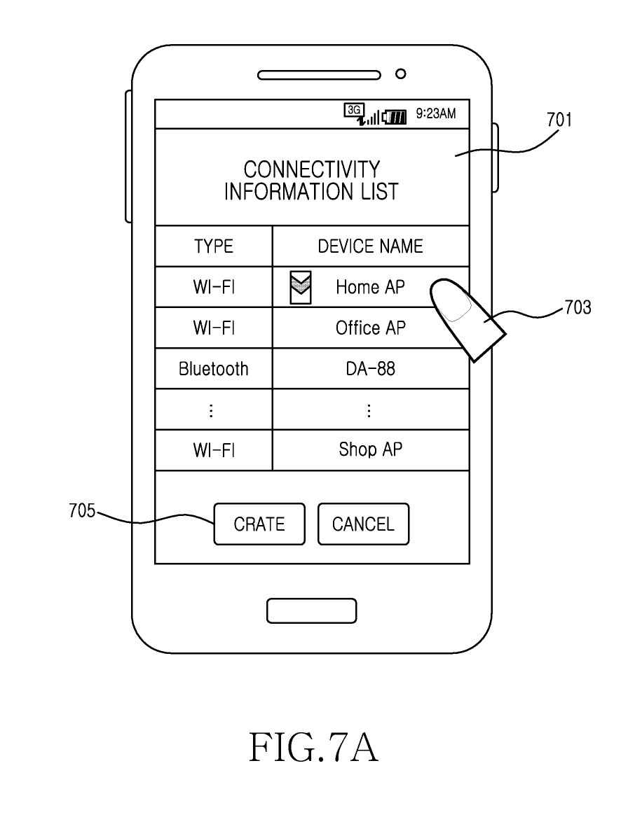

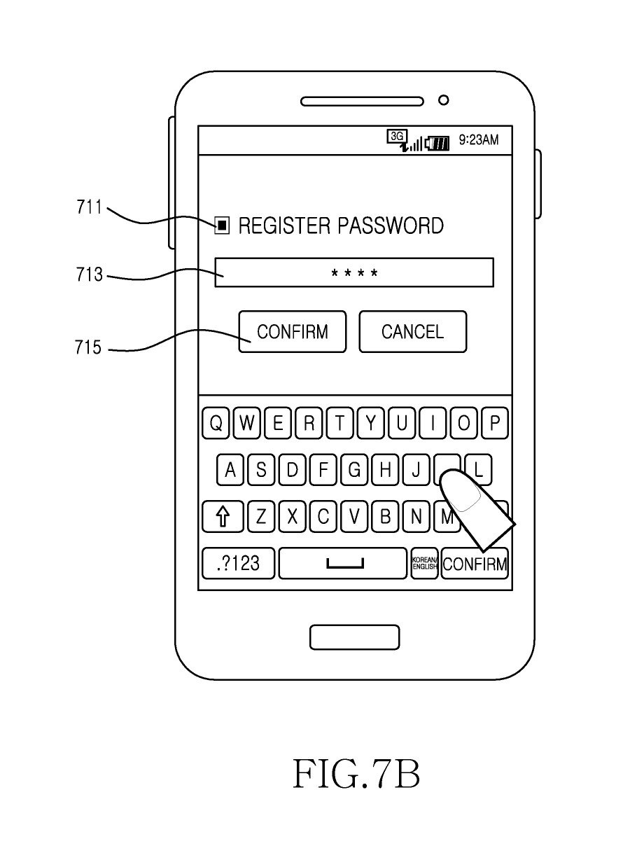

If at (401) the connectivity information package creation event occurs, then at (403), the electronic device displays a connectivity information list. For example, as illustrated in FIG. 7A, the electronic device displays a connectivity information list 701 including information indicating a connectivity with the wireless device on the display unit 150. Herein, the connectivity information includes at least one of a name, connectivity type, physical address, authentication status, authentication type, encryption type, and password of the wireless device as illustrated herein below in Table 1.

TABLE 1
Connection information

| | |
|---|---|
| name | Home AP |
| connectivity type | Wi-Fi |
| physical address | FX-00-88-AA-CC-MM |
| authentication status | YES |
| authentication type | WPAPSK |
| encryption type | AES |
| password | 1234ABCD |
| . . . | . . . |

After displaying the connectivity information list, then at (405) the electronic device confirms whether the connectivity information is selected. For example, as illustrated in FIG. 7A, the electronic device confirms at least one piece of connectivity information selected by a user (703) from among a plurality of pieces of connectivity information included in the connectivity information list 701.

Referring again to FIG. 4, when at (405) the connectivity information is selected, then at (407), the electronic device creates a connectivity information package. In this case, it is assumed that the electronic device encodes the connectivity information package to create it as a file. For example, if a “create” menu 705 is selected as illustrated in FIG. 7A, the electronic device creates a connectivity information package including at least one piece of connectivity information selected from among the plurality of pieces of connectivity information.

Thereafter, the procedure of FIG. 4 ends.

In addition, after creating the connectivity information package, the electronic device can transmit the connectivity information package by using at least one of wireless/wired communication and storage devices.

In the aforementioned embodiment, the electronic device creates the connectivity information package. In another embodiment, the electronic device may determine to authenticate the connectivity information package.

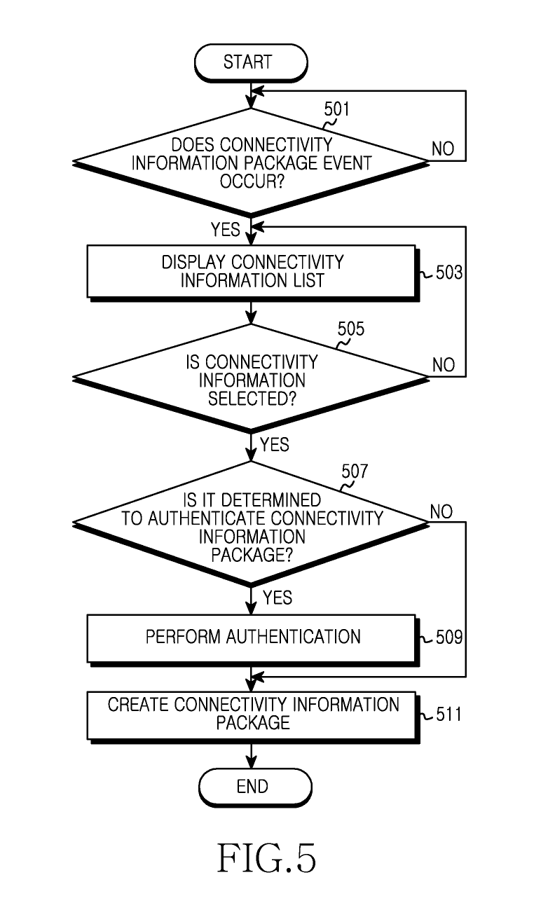

FIG. 5 illustrates an example of an operation of a process of determining whether to authenticate a connectivity information package in an electronic device according to an exemplary embodiment of the present disclosure.

Referring now to FIG. 5, at (511) the electronic device confirms whether a connectivity information package creation event occurs. In one example, the electronic device confirms whether an icon for creating the connectivity information package is selected. In another example, the electronic device may confirm whether the connectivity information package creation event occurs by considering input information of a hardware button. In yet another example, whether the connectivity information package creation event occurs can be confirmed by considering the input information of the hardware button and movement information of the electronic device. In still another example, an electronic device having a touch screen can determine whether the connectivity information package creation event occurs by considering touch information on the touch screen. In another example, the electronic device having the touch screen can determine whether the connectivity information package creation event occurs by considering the touch information on the touch screen and the movement information of the electronic device.

At (501), after the connectivity information package creation event occurs, at (503) the electronic device displays a connectivity information list. For example, as illustrated in FIG. 7A, the electronic device displays a connectivity information list 701 including information indicating a connectivity with the wireless device on the display unit 150. Herein, the connectivity information includes at least one of a name, connectivity type, physical address, authentication status, authentication type, encryption type, and password of the wireless device as illustrated in Table 1.

After displaying the connectivity information list, at (505) the electronic device confirms whether the connectivity information is selected. For example, as illustrated in FIG. 7A, the electronic device confirms at least one piece of connectivity information selected by a user from among a plurality of pieces of connectivity information included in the connectivity information list 701 (see 703).

In the case at (505) that the connectivity information is selected, at (507), the electronic device confirms whether to authenticate a connectivity information package.

For example, if a “create” menu 705 is selected as illustrated in FIG. 7A, the electronic device recognizes that a connectivity information package is created which includes at least one piece of connectivity information selected from among the plurality of pieces of connectivity information. Accordingly, the electronic device displays a “confirm” menu on the display unit 150 to confirm whether to authenticate the connectivity information package.

In the case at (507) where the processor determines to authenticate the connectivity information package, at (509) the electronic device authenticates the connectivity information package. For example, if a password 713 is input by a user as illustrated in FIG. 7B and thereafter selection of a “confirm” menu 715 is detected, and the electronic device determines to authenticate the connectivity information package.

After determining at (509) to authenticate the connectivity information package, at (511) the electronic device creates the connectivity information package. In this case, it is assumed that the electronic device encodes the connectivity information package for creation as a file.

Thereafter, the procedure of FIG. 5 ends.

In addition, after creating the connectivity information package, the electronic device can transmit the connectivity information package by using at least one of wireless/wired communication and storage devices.

In the aforementioned embodiment, the electronic device determines whether to authenticate the connectivity information package. In another embodiment, the electronic device may determine whether to validate the connectivity information package.

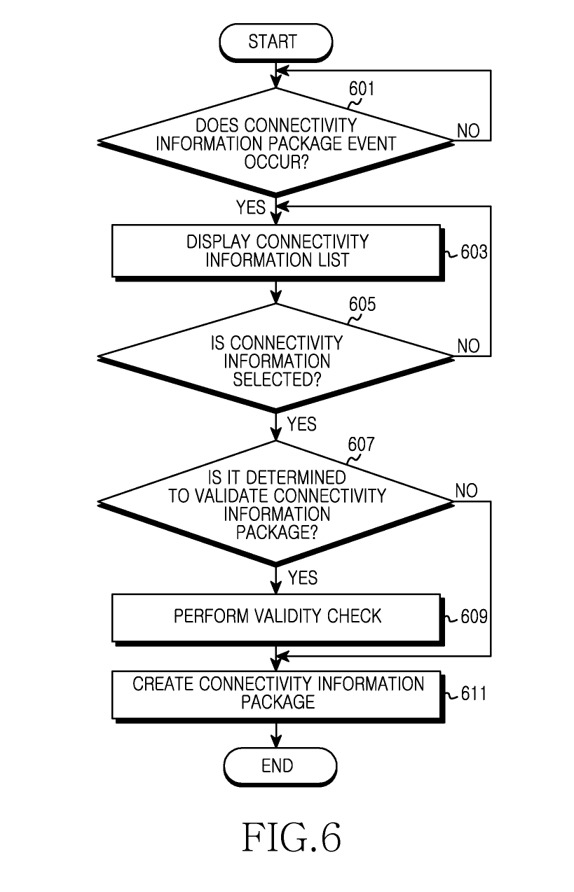

FIG. 6 illustrates an operational example of a process of determining a validity of a connectivity information package in an electronic device according to an exemplary embodiment of the present disclosure.

Referring now to FIG. 6, at (601) the electronic device confirms whether a connectivity information package creation event occurs. In one example, the electronic device confirms whether an icon for creating the connectivity information package is selected. In another example, the electronic device can confirm whether the connectivity information package creation event occurs by detecting input information of a hardware button or virtual button. For another example, whether the connectivity information package creation event occurs can be determined by considering the input information of, for example, the hardware button and movement information of the electronic device. In yet another example, an electronic device having a touch screen can determine whether the connectivity information package creation event occurs by considering touch information on the touch screen. In another example, the electronic device having the touch screen can determine whether the connectivity information package creation event occurs by considering the touch information on the touch screen and the movement information of the electronic device.

In the case at (601) that the connectivity information package creation event occurs, at (603) the electronic device displays a connectivity information list. For example, as illustrated in FIG. 7A, the electronic device displays on display unit 150 a connectivity information list 701 including information indicating a connectivity with the wireless device. Herein, the connectivity information includes at least one or more of a name, connectivity type, physical address, authentication status, authentication type, encryption type, and password of the wireless device as illustrated in Table 1.

After displaying at (603) the connectivity information list, at (605) the electronic device confirms whether the connectivity information is selected. For example, as illustrated in FIG. 7A, the electronic device confirms at least one or more of a piece of connectivity information selected by a user among a plurality of pieces of connectivity information included in the connectivity information list 701 (see 703).

In the case at (605) where the connectivity information is selected, at (607) the electronic device determines whether to validate a connectivity information package. For example, if a “create” menu 705 is selected as illustrated in FIG. 7A, the electronic device recognizes that a connectivity information package is created which includes at least one piece of connectivity information selected among the plurality of pieces of connectivity information. Accordingly, the electronic device displays a menu for confirming whether to validate the connectivity information package on the display unit 150.

At (609), the electronic device validates the connectivity information package. In one example, the electronic device determines a valid duration in the connectivity information package so that the connectivity information package cannot be used after a reference time. In another example, the electronic device may include at least one of a physical address (i.e., Media Access Control (MAC) address), device IDentifier (ID) (i.e., DeviceID), and phone number of an electronic device for receiving the connectivity information package so that the connectivity information package can be utilized only in a specific electronic device.

After determining at (609) the validity of the connectivity information package, at (611) the electronic device creates the connectivity information package. In this case, it is assumed that the electronic device encodes the connectivity information package to create it as a file.

Thereafter, the procedure of FIG. 6 ends.

In addition, after creating the connectivity information package, the electronic device can transmit the connectivity information package by using at least one of wireless/wired communication and storage devices.

In the aforementioned embodiment, the electronic device creates the connectivity information package. In another embodiment, the electronic device may establish a connection with a device by using the created connectivity information package.

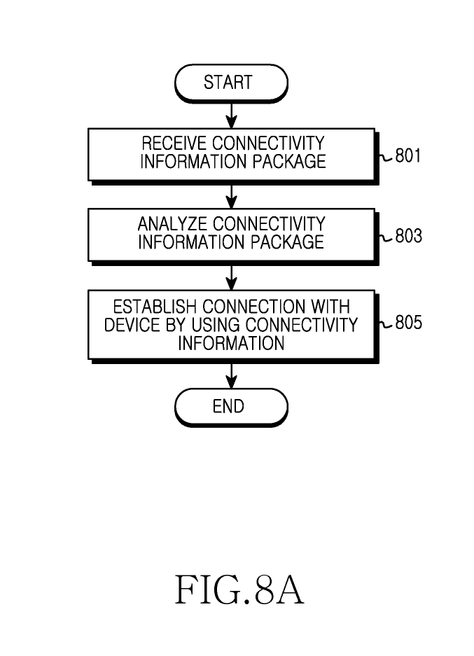

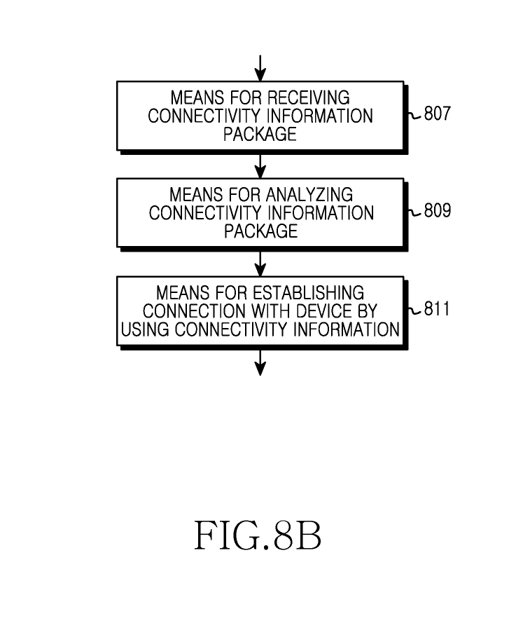

FIG. 8A illustrates an exemplary operation of a process of establishing a connection with a device by considering connectivity information in an electronic device according to a first exemplary embodiment of the present disclosure.

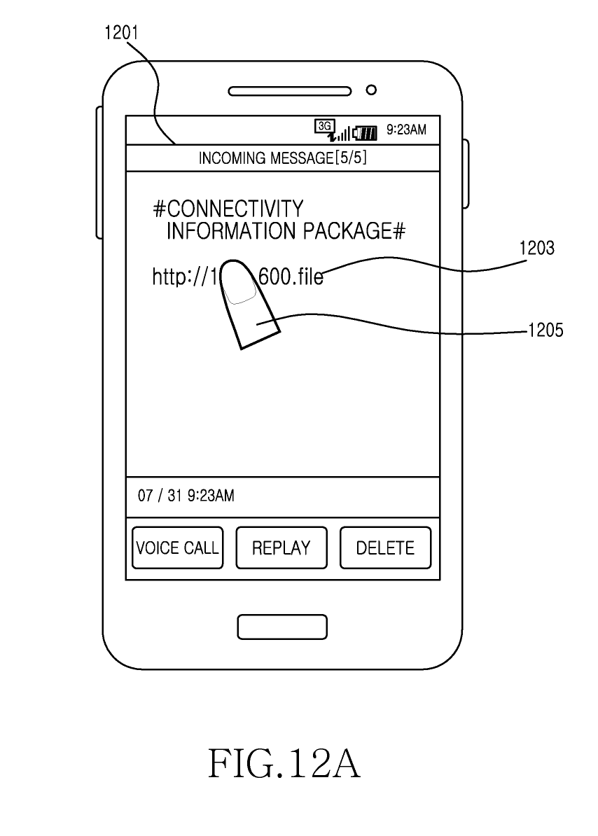

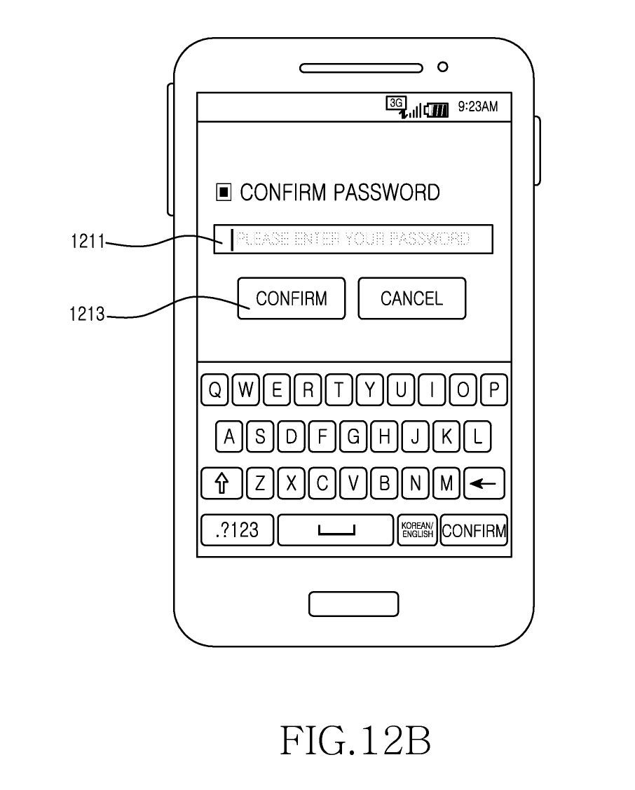

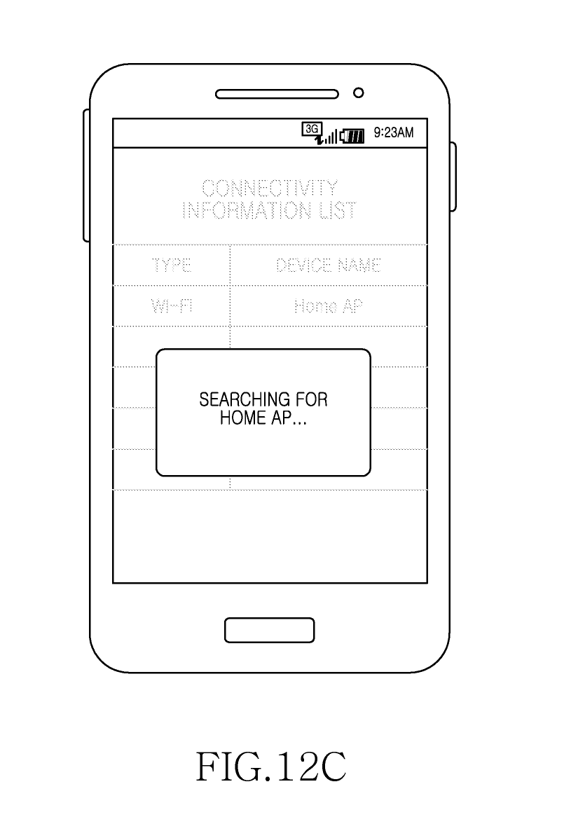

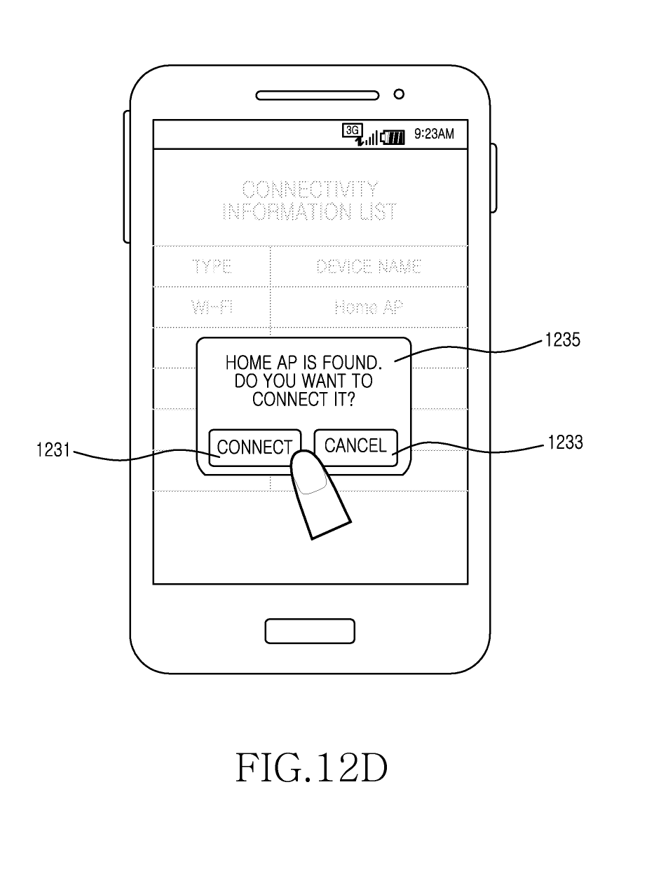

Referring now to FIG. 8A, at (801) the electronic device receives a connectivity information package. In one example, as illustrated in FIG. 12A, a message application program 1201 is used to receive a message including a link 1203 capable of receiving the connectivity information package, and if the link 1203 is selected at a later time, the electronic device recognizes that the connectivity information package is received. For another example, the electronic device can receive the connectivity information package by using at least one of wired communication and storage devices.

After receiving at (801) the connectivity information package, at (803) the electronic device analyzes the connectivity information package. In this case, it is assumed that the electronic device analyzes the connectivity information package by decoding it.

For example, the electronic device confirms connectivity information from the connectivity information package. The connectivity information is analyzed to be determined whether there at least one or more of a name, connectivity type, physical address, authentication status, authentication type, encryption type, and password of the wireless device has been included. In this case, the electronic device adds at least one piece of connectivity information included in the connectivity information package to a connectivity information list.

After analyzing at (803) the connectivity information package, at (805) the electronic device establishes a connection with the device by using the connectivity information included in the connectivity information package. In this case, to confirm whether to establish the connection with the detected device as illustrated in FIG. 12D, the electronic device may display a confirm window 1235 including a “connect” menu 1231 and a “cancel” menu on the display unit 150.

Thereafter, the procedure of FIG. 8A ends.

In addition, after receiving the connectivity information package, the electronic device may authenticate the connectivity information package to analyze the connectivity information package. In addition, the electronic device may determine a validity of the connectivity information package.

As described above, each process for establishing the connection with the device by considering the connectivity information in the electronic device may be configured by a means for establishing the connection with the device by considering the connectivity information in the electronic device as illustrated in FIG. 8B.

FIG. 8B illustrates a structure of an electronic device for establishing a connection with a device by considering connectivity information in an electronic device according to an exemplary embodiment of the present disclosure.

Referring now to FIG. 8B, the electronic device includes a first means 807 for receiving a connectivity information package, a second means 809 for analyzing the connectivity information package, and a third means 811 for establishing a connection with a device by using connectivity information included in the connectivity information package. An artisan should understand and appreciate that the use of “means” in this particular embodiment does not constitute an admission that the entirety of the claimed subject matter lacks sufficient structure, materials or acts described in the specification for the artisan to practice the disclosure.

The first means 807 receives the connectivity information package. In one example, as illustrated in FIG. 12A, a message application program 1201 is used to receive a message including a link 1203 capable of receiving the connectivity information package, and if the link 1203 is selected by a user at a later time, the electronic device recognizes that the connectivity information package is received. For another example, the electronic device can receive the connectivity information package by using at least one of wired communication and storage devices.

The second means 809 analyzes the connectivity information package. In this case, it is assumed that the electronic device analyzes the connectivity information package by decoding it. For example, the electronic device confirms connectivity information from the connectivity information package. The connectivity information includes at least one of a name, connectivity type, physical address, authentication status, authentication type, encryption type, and password of the wireless device. In this case, the electronic device adds at least one piece of connectivity information included in the connectivity information package to a connectivity information list.

With continued reference to FIG. 8B, the third means 811 establishes a connection with a device by using the connectivity information included in the connectivity information package. In this case, to confirm whether to establish the connection with the detected device as illustrated in FIG. 12D, the electronic device may display a confirm window 1235 including a “connect” menu 1231 and a “cancel” menu on the display unit 150.

In addition, after receiving the connectivity information package, the electronic device may authenticate the connectivity information package to analyze the connectivity information package. In addition, the electronic device may determine a validity of the connectivity information package.

As described in the above example in conjunction with FIG. 8B, the electronic device includes various means for establishing a connection with a device by considering connectivity information. In this case, the electronic device may configure respective means for establishing the connection with the device by considering the connectivity information as one means.

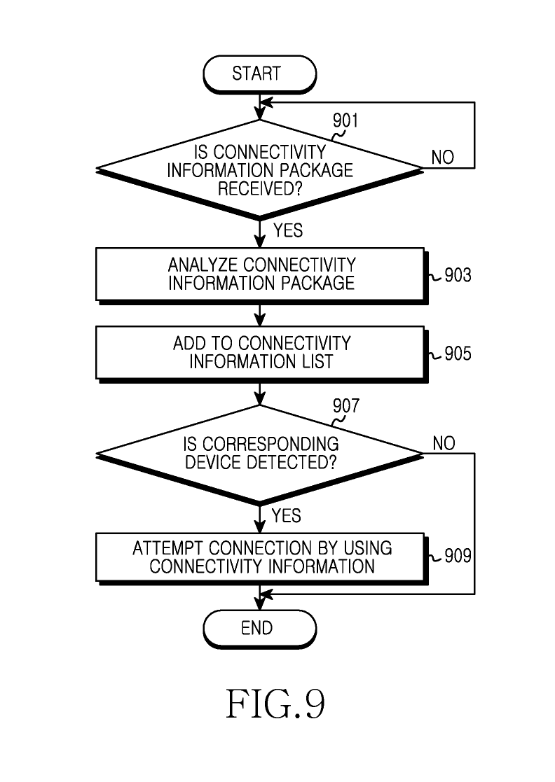

FIG. 9 illustrates a process of establishing a connection with a device by considering connectivity information in an electronic device according to another exemplary embodiment of the present disclosure.

Referring now to FIG. 9, at (901) the electronic device confirms whether a connectivity information package is received. In one example, as illustrated in FIG. 12A, a message application program 1201 is used to receive a message including a link 1203 capable of receiving the connectivity information package, and if the link 1203 is selected by a user at a later time, the electronic device recognizes that the connectivity information package is received. In another example, the electronic device can receive the connectivity information package by using at least one of wired communication and storage devices.

After receiving the connectivity information package, at (903) the electronic device analyzes the connectivity information package. In this case, it is assumed that the electronic device analyzes the connectivity information package by decoding it. For example, the electronic device confirms connectivity information from the connectivity information package. The connectivity information includes at least one of a name, connectivity type, physical address, authentication status, authentication type, encryption type, and password of the wireless device.

After analyzing the connectivity information package, at (905) the electronic device adds at least one piece of connectivity information included in the connectivity information package to a connectivity information list.

After adding (at 905) to the connectivity information list, at (907) the electronic device confirms whether a corresponding device is detected. If the connectivity information is plural in number, the electronic device may sequentially detect a device corresponding to the connectivity information.

Upon detection at (907) of the corresponding device, at (909) the electronic device attempts the connection by using the connectivity information. In this case, to confirm whether to establish the connection with the detected device as illustrated in FIG. 12D, the electronic device may display a confirm window 1235 including a “connect” menu 1231 and a “cancel” menu on the display unit 150.

Thereafter, the procedure of FIG. 9 ends.

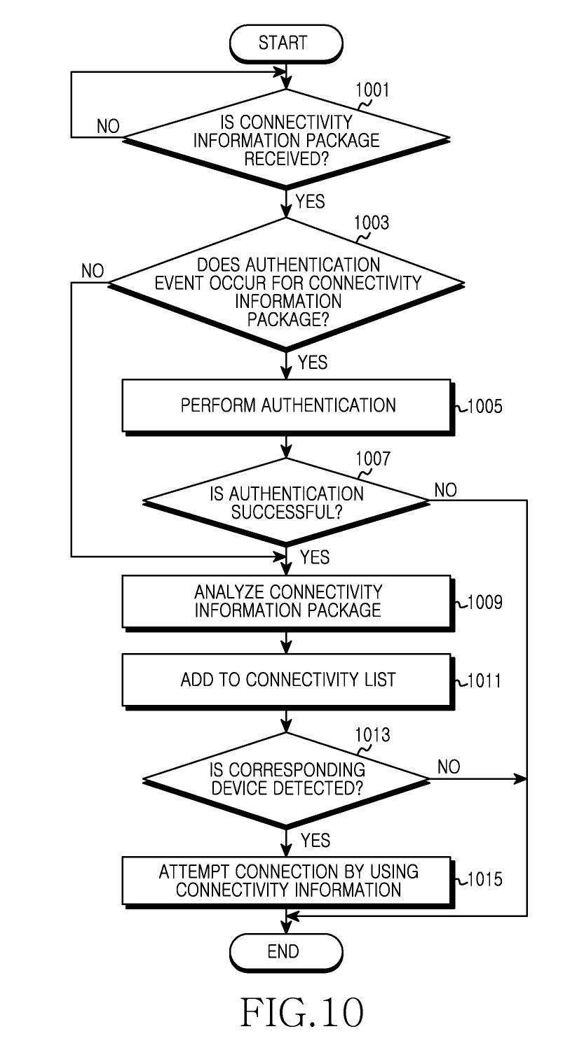

FIG. 10 illustrates a process of authenticating a connectivity information package in an electronic device according to an exemplary embodiment of the present disclosure.

Referring now to FIG. 10, at (1001) the electronic device confirms whether a connectivity information package is received. In one example, as illustrated in FIG. 12A, a message application program 1201 is used to receive a message including a link 1203 capable of receiving the connectivity information package, and if the link 1203 is selected by a user at a later time, the electronic device recognizes that the connectivity information package is received. In another example, the electronic device can receive the connectivity information package by using at least one of wired communication and storage devices.

After receiving at (1001) the connectivity information package, at (1003) the electronic device confirms whether an authentication event occurs for the connectivity information package.

In the case at (1003) where the authentication event occurs for the connectivity information package, at (1005) the electronic device authenticates the connectivity information package. For example, in the case where a password is input by a user as illustrated in FIG. 12B, the electronic device confirms whether a “confirm” menu 1213 is selected.

After performing at (1005) the authentication, at (1007) the electronic device confirms whether the authentication is successful. For example, if the “confirm” menu 1213 is selected as illustrated in FIG. 12B, the electronic device determines whether a password used for the authentication and included in the connectivity information package is equal to a password which is input by the user.

In the case where at (1007) the authentication is successful, at (1009) the electronic device analyzes the connectivity information package. In this case, it is assumed that the electronic device analyzes the connectivity information package by decoding it. For example, the electronic device confirms connectivity information from the connectivity information package. The connectivity information includes at least one of a name, connectivity type, physical address, authentication status, authentication type, encryption type, and password of the wireless device.

After analyzing at (1009) the connectivity information package, at (1011) the electronic device adds at least one piece of connectivity information included in the connectivity information package to a connectivity information list.

After adding at (1011) to the connectivity information list, at (1013) the electronic device confirms whether a corresponding device is detected. In the case where the connectivity information is plural in number, the electronic device may sequentially detect a device corresponding to the connectivity information.

Upon detection at (1013) of the corresponding device, at (1015) the electronic device attempts the connection by using the connectivity information. In this case, to confirm whether to establish the connection with the detected device as illustrated in FIG. 12D, the electronic device may display a confirm window 1235 including a “connect” menu 1231 and a “cancel” menu on the display unit 150.

Thereafter, the procedure of FIG. 10 ends.

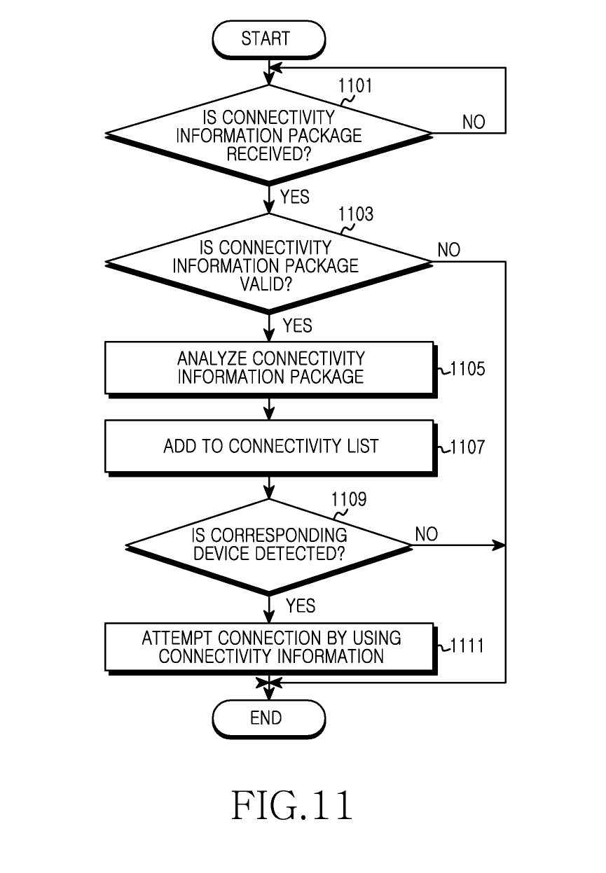

FIG. 11 illustrates a process of determining a validity of a connectivity information package in an electronic device according to an exemplary embodiment of the present disclosure. FIG. 11 will be discussed in conjunction with FIGS. 12A, 12B, 12C and 12D. FIGS. 12A, 12B, 12C and 12D illustrate a screen configuration for establishing a connection with a device by considering connectivity information in an electronic device according to an exemplary embodiment of the present disclosure.

Referring now to FIG. 11, at (1101) the electronic device confirms whether a connectivity information package is received. In one example, as illustrated in FIG. 12A, a message application program 1201 is used to receive a message including a link 1203 capable of receiving the connectivity information package, and if the link 1203 is selected by a user at a later time, the electronic device recognizes that the connectivity information package is received. For another example, the electronic device can receive the connectivity information package by using at least one of wired communication and storage devices.

After receiving at (1101) the connectivity information package, at (1103) the electronic device confirms a validity of the connectivity information package. In one example, if a valid duration of the connectivity information package is not over, the electronic device recognizes that the connectivity information package is valid. In another example, whether the connectivity information package is valid can be confirmed by considering at least one piece of information included to determine the validity, i.e., at least one of a physical address (i.e., MAC address), device ID (i.e., DeviceID), and phone number of the electronic device.

In the case where at (1103) the connectivity information package is valid, at (1105) the electronic device analyzes the connectivity information package. In this case, there is an assumption that the electronic device analyzes the connectivity information package by decoding the connectivity information. For example, the electronic device confirms connectivity information from the connectivity information package. The connectivity information includes at least one or more of a name, connectivity type, physical address, authentication status, authentication type, encryption type, and password of the wireless device.

After analyzing at (1105) the connectivity information package, at (1107), the electronic device adds at least one connectivity information included in the connectivity information package to a connectivity information list.

After adding at (1107) to the connectivity information list, at (1109) the electronic device confirms whether a corresponding device is detected. If the connectivity information is plural in number, the electronic device may sequentially detect a device corresponding to the connectivity information.

Upon detection at (1109) of the corresponding device, at (1111) the electronic device attempts the connection by using the connectivity information as also shown in FIG. 12C. In this case, to confirm whether to establish the connection with the detected device as illustrated in FIG. 12D, the electronic device may display a confirm window 1235 including a “connect” menu 1231 and a “cancel” menu on the display unit 150.

Thereafter, the procedure of FIG. 11 ends.

In the aforementioned embodiment there is an assumption that the electronic device includes a process of detecting an error in a received connectivity information package file.

As described above, the electronic device receives connectivity information, and thereafter establishes a connection with a wireless device by using the connectivity information. Therefore, there is an advantage in that a user of the electronic device can easily establish the connection with the wireless device.

The above-described apparatus and a method of operation according to the present disclosure can be implemented in hardware, and in part as firmware or via the execution of software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed disclosure. Under the broadest reasonable interpretation, the appended claims constitute statutory subject matter in compliance with 35 U.S.C. §101.

The terms “unit” or “module” referred to herein is to be understood as constituting hardware such as a processor or microprocessor configured for a certain desired functionality, or a non-transitory medium comprising machine executable code, in accordance with statutory subject matter under 35 U.S.C. §101 and does not constitute software per se.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method of receiving connectivity information in an electronic device, the method comprising:
receiving from another electronic device connectivity information regarding at least one wireless device of the another electronic device;
analyzing by the processor unit the received connectivity information regarding the at least one wireless device; and
establishing a connection by the electronic device with a neighbor wireless device based on the connectivity information received by the another electronic device.

2. The method of claim 1, wherein the connectivity information is analyzed to identify at least one or more of a name, connectivity type, physical address, authentication status, authentication type, encryption type, and password of the wireless device.

3. The method of claim 1, further comprising, after analyzing the connectivity information by the processor unit, storing the connectivity information as a list.

4. The method of claim 3, further comprising the processor unit controls, prior to the storing of the connectivity information as the list, a decoding the received connectivity information.

5. The method of claim 1, further comprising, after the processor unit of the electronic device receiving the connectivity information, confirming whether the connectivity information is authenticated.

6. The method of claim 1, wherein the analyzing of the connectivity information includes receiving the connectivity information and thereafter determining a validity of the connectivity information.

7. The method of claim 6, wherein the determining of the validity includes detecting whether an error exists in a file regarding the received connectivity information.

8. A method of transmitting connectivity information, the method comprising:
creating by a connectivity information control program executed by a processor of an electronic device, connectivity information regarding at least one wireless device of the electronic device; and
transmitting the created connectivity information regarding the at least one wireless device to another electronic device for connecting with the at least one wireless device.

9. The method of claim 8, further comprising, after the creating of the connectivity information, storing the created connectivity information in a storage medium.

10. The method of claim 9, further comprising encoding the created connectivity information prior to the storing of the connectivity information.

11. The method of claim 8, further comprising determining whether the connectivity information is authenticated prior to the transmitting of the connectivity information to the another electronic device.

12. An electronic device comprising:
at least one processor;
at least one touch screen;
a memory; and
at least one program stored in the memory and configured to be executable by the at least one processor,
wherein the program includes at least one instruction that is executed by the at least one processor for receiving from another wireless electronic device a transmission of connectivity information regarding at least one wireless device of said another wireless device, analyzing the received connectivity information, and establishing a connection with a at least one neighbor wireless device based on the connectivity information.

13. The electronic device of claim 12, wherein the program further includes an instruction for storing the connectivity information as a list after analyzing the connectivity information.

14. The electronic device of claim 13, wherein the program further includes an instruction for decoding the received connectivity information.

15. The electronic device of claim 12, wherein the program further includes an instruction for confirming whether the connectivity information is authenticated.

16. The electronic device of claim 12, wherein the instruction for analyzing the connectivity information is for receiving the connectivity information and thereafter determining a validity of the connectivity information.

17. The electronic device of claim 16, wherein the instruction for determining of the validity is for detecting an error in a file for the received connectivity information.

18. An electronic device comprising:
at least one processor;
at least one touch screen;
a memory; and
at least one program stored in the memory and configured to be executable by the at least one processor,
wherein the program includes at least one instruction executed by the at least one processor for creating connectivity information regarding at least one wireless device, and transmitting the created connectivity information.

19. The electronic device of claim 18, wherein the program further includes an instruction for storing the created connectivity information in a storage medium.

20. The electronic device of claim 19, wherein the program further includes an instruction for encoding the created connectivity information.

21. The electronic device of claim 18, wherein the program further includes an instruction for determining whether the connectivity information is authenticated.

22. A system for transmitting and receiving connectivity information in an electronic device, the system comprising:
a first electronic device for creating and transmitting connectivity information regarding at least one wireless device of the first electronic device; and
a second electronic device for receiving the connectivity information regarding the at least one wireless device created and transmitted by the first electronic device and for establishing a connection by the second electronic device with said at least one neighbor wireless device by using the received connectivity information.

23. The system of claim 22, wherein the first electronic device transmits the connectivity information by encoding the connectivity information.

24. The system of claim 22, wherein the first electronic device determines whether the connectivity information is authenticated before transmitting the connectivity information.

25. The system of claim 22, wherein the second electronic device decodes the received connectivity information.

26. The system of claim 22, wherein the second electronic device determines a validity of the received connectivity information.
